(19) United States
(12) Patent Application Publication
(10) Pub. No.: US 2025/0094318 A1
(43) Pub. Date: Mar. 20, 2025

(54) MULTI-ARCHITECTURE RAPID TESTING FRAMEWORK

(71) Applicant: Oracle International Corporation, Redwood Shores, CA (US)

(72) Inventor: Timothy Clegg, Custer, SD (US)

(21) Appl. No.: 18/467,187

(22) Filed: Sep. 14, 2023

(51) Int. Cl. G06F 11/36; G06F 8/41

(52) U.S. Cl. CPC G06F 11/3616; G06F 8/47; G06F 11/3698

(57) ABSTRACT

Examples provide a computer system including an electronic processor configured to obtain a set of source code and a plurality of test scenarios. Each of the plurality of test scenarios specifies a respective build architecture. For each respective test scenario of the plurality of test scenarios, the electronic processor is configured to instantiate a respective build environment according to the respective build architecture, compile the set of source code in the respective build environment to generate a respective binary file, and generate a respective set of one or more metrics for the respective binary file.

### FIELD

Embodiments described herein generally relate to testing and analyzing source code compiled in different test scenarios, such as, for example, using different compilation methods.

### SUMMARY

When an application (a set of source code) written in a given programming language is compiled, linked, and built, the resulting machine code (a binary file) varies according to the target central processing unit (“CPU”) architecture. Several compilation techniques and optimization adjustments exist, such as for example, native compilation (e.g., on a local machine or in a container), emulation, or cross-compilation. Therefore, developers must determine which techniques and adjustments are best suited for the target CPU architecture and the application purpose. For example, a first compilation technique may yield a much larger binary size than a second compilation technique. A developer may need to determine which binaries are safe to use, which binaries are better suited for a target architecture, and the like. Given the various options available, it is difficult for a developer to know how to build a binary file, which results in, among other things, inefficient use of computing resources (through the use of inefficient or unstable binaries) and poor memory usage (through the use of large binaries when smaller binaries are available).

Thus, there is a need for a multi-architecture rapid testing (“MART”) framework that addresses these and other technical problems. The framework described herein provide a software development tool configured to build, test, and analyze application binaries in different test scenarios (e.g., different target architectures, different compilation techniques, different optimization settings, etc.). The results of this analysis can govern how to build a stable and efficient application for a particular scenario (e.g., target computer architecture and/or operating system where the application will be executed). One example provides a system including an electronic processor configured to obtain a set of source code, and obtain a plurality of test scenarios. Each of the plurality of test scenarios specifies a respective build architecture. For each respective test scenario of the plurality of test scenarios, the electronic processor is further configured to instantiate a respective build environment according to the respective build architecture compile the set of source code in the respective build environment to generate a respective binary file, and generate a respective set of one or more metrics for the respective binary file.

In some aspects, each of the plurality of test scenarios further specifies a respective target architecture, and compiling the set of source code in the respective build environment includes compiling the source code for execution in the respective target architecture.

In some aspects, each of the plurality of test scenarios further specifies a respective build operating system and a respective target operating system, instantiating the respective build environment includes instantiating the respective build environment using the respective build operating system, and compiling the set of source code in the respective build environment includes generating the respective binary file for execution in the respective target operating system.

In some aspects, each of the plurality of test scenarios further specifies a respective compilation method, and compiling the set of source code in the respective build environment includes compiling the source code using the respective compilation method.

In some aspects, the respective compilation method includes one selected from a group consisting of a native compilation, an emulated compilation, and a cross-compilation.

In some aspects, the electronic processor is further configured to obtain a plurality of compute types, and obtain a plurality of compilation methods. Obtaining the plurality of test scenarios includes generating the plurality of test scenarios based on permutations of the plurality of compute types and the plurality of compilation methods.

In some aspects, each of the plurality of compute types includes a respective build architecture and a respective target architecture and wherein the plurality of compilation methods includes a native compilation, a emulated compilation, and a cross-compilation.

In some aspects, instantiating the respective build environment includes installing dependencies a virtual machine.

In some aspects, instantiating the respective build environment includes copying application dependencies of the set of source code to the virtual machine.

In some aspects, instantiating the respective build environment includes instantiating a container.

In some aspects, the set of one or more metrics includes at least one selected from the group consisting of a file size of the respective binary file, a page size of the respective build environment, a number of CPUs in the respective build environment, a model of CPUs in the respective build environment, CPU flags in the respective build environment, and a number of strings included in the respective binary file.

Another example provides a system including an electronic processor configured to receive, via a user interface, user input indicating a plurality of build architectures to be used in compiling a set of source code; instantiate a plurality of build environments, wherein each of the plurality of build environments is instantiated respectively according to the plurality of build architectures; compile the set of source code in each of the plurality of build environments to generate a respective binary file; and present, via the user interface, a respective set of one or more metrics corresponding to each respective binary file.

In some aspects, the user input received via the user interface further indicates a plurality of build operating systems, wherein each of the plurality of build environments is instantiated respectively according to the plurality of build operating systems.

In some aspects, the user input received via the user interface further indicates a plurality of target operating systems, wherein each respective binary file is generated respectively according to the plurality of target operating systems.

In some aspects, the user input received via the user interface further indicates a plurality of compilation methods, wherein compiling the set of source code in each of the plurality of build environments comprises compiling the set of source code respectively according to the plurality of compilation strategies.

In some aspects, the electronic processor is further configured to provide, via the user interface, a list of available build architectures and wherein the user input includes a selection of one or more build architectures from the list of available build architectures.

In some aspects, the electronic processor is configured to receive the user input indicating the plurality of build architectures via a dropdown menu included in the user interface.

Another example provides a method for testing binary files. The method includes obtaining, with an electronic processor, a plurality of compute types and a plurality of compilation methods, each of the plurality of compute types specifying respective build architecture; generating, with the electronic processor, a plurality of test scenarios based on permutations of the plurality of compute types and the plurality of compilation methods, wherein each of the plurality of test scenarios specifies a respective build architecture from the set of build architectures and a respective compilation method from the plurality of compilation methods; and for each respective test scenarios of the plurality of test scenarios: instantiating a respective build environment according to the respective build architecture, compiling the set of source code in the respective build environment using the respective compilation method to generate a respective binary file, and generating a respective set of one or more metrics for the respective binary file.

In some aspects, each of the plurality of compute types further specifies a respective target architecture and wherein compiling the set of source code in the respective build environment includes generating the respective binary file for the respective target architecture.

In some aspects, the set of one or more metrics includes at least one selected from the group consisting of a file size of the respective binary file, a page size of the respective build environment, a number of CPUs in the respective build environment, a model of CPUs in the respective build environment, CPU flags in the respective build environment, and a number of strings included in the respective binary file.

Other aspects of the invention will become apparent by consideration of the detailed description and accompanying drawings.

### BRIEF DESCRIPTION OF THE DRAWINGS

FIG. 1 is a block diagram illustrating one pattern for implementing a cloud infrastructure as a service system, according to at least one embodiment.

FIG. 2 is a block diagram illustrating another pattern for implementing a cloud infrastructure as a service system, according to at least one embodiment.

FIG. 3 is a block diagram illustrating another pattern for implementing a cloud infrastructure as a service system, according to at least one embodiment.

FIG. 4 is a block diagram illustrating another pattern for implementing a cloud infrastructure as a service system, according to at least one embodiment.

FIG. 5 is a block diagram illustrating an example computer system, according to at least one embodiment.

FIG. 6 is a block diagram illustrating a system architecture 600 for executing multi-architecture rapid testing, according to at least one embodiment.

FIG. 7 is a block diagram illustrating a first example user interface for receiving multi-architecture rapid testing framework inputs, according to at least one embodiment.

FIG. 8 is a block diagram illustrating a second example user interface for receiving multi-architecture rapid testing framework inputs, according to at least one embodiment.

FIG. 9 is a block diagram illustrating a method for testing and analyzing source code compiled in a respective build environment, according to at least one embodiment.

FIG. 10 is a block diagram illustrating a multi-architecture rapid testing process performed for a plurality of permutations of compute types and commands, according to at least one embodiment.

FIG. 11 is a block diagram illustrating an example set of metrics that may be displayed to a user interface, according to at least one embodiment.

FIG. 12 is a flowchart illustrating an example method for performing multi-architecture rapid testing of source code, according to at least one embodiment.

### DETAILED DESCRIPTION

In the following description, various embodiments will be described. For purposes of explanation, specific configurations and details are set forth to provide a thorough understanding of the embodiments. However, it will also be apparent to one skilled in the art that the embodiments may be practiced without the specific details. Furthermore, well-known features may be omitted or simplified in order not to obscure the embodiment being described.

### Terminology

Before disclosing the subject matter in greater detail, some context including terminology used herein is introduced.

As used herein, the terms “build” and “compilation” include processes in which source code (e.g., clear or human-readable text) is converted into an executable binary format (e.g., machine code or a binary file, which may include one or more files or other data structures). The terms “source code” and a “set of source code,” as used in the present application, are used interchangeably to refer to one or more source code files or other data structures.

As used herein, the term “tool chain” includes a set of applications, libraries, and supporting data used to build an application. A tool chain may be specific to a given target architecture (e.g., aarch64).

As used herein, the term “cross-compilation” includes a compilation technique in which a full development tool chain (e.g., compiler, linker, libraries, etc.) is installed for a given target architecture that differs from the machine architecture performing the compilation. Cross-compilation enables a host machine to build binaries for different target architectures. For example, a cloud infrastructure (CI) instance with a first computer (central processing unit (“CPU”)) architecture (e.g., a x86_64 Oracle® Cloud Environment instance) may have a tool chain installed for building binaries for execution in a different (“target”) architecture (e.g., aarch64 binaries).

As used herein, the term “emulated compilation” includes a compilation technique in which a target computer architecture is emulated (e.g., using software). Emulated compilation enables execution of a toolchain for a target architecture that is different than the host machine's architecture to build, compile, or link an application.

As used herein, the term “native compilation” includes the process of building an application binary for which the build environment uses the same computer architecture as the target architecture. For example, compiling an aarch64 application on an aarch64 (A1) CI instance is a native compilation.

As used herein, the term “build architecture” or “build computer architecture” generally refers the CPU architecture of the machine (e.g., a virtual machine, a bare metal machine, the local machine, etc.) performing compilation of a set of source code. For example, a local machine may instantiate a build environment in a virtual machine according to a defined build architecture (e.g., x86_64).

As used herein, the term “target architecture” or “target computer architecture” generally refers to the destination CPU architecture of a build. Source code may be compiled for execution in a different target architecture than the architecture of the build environment. For example, source code associated with an x86_64 build architecture may be ported for an aarch64 target architecture.

### Cloud-Based Computing Platforms

Embodiments described herein may performed, wholly or partly, within a cloud-based computing platform. Cloud-based computing platforms provide scalable and flexible computing resources for users. Infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

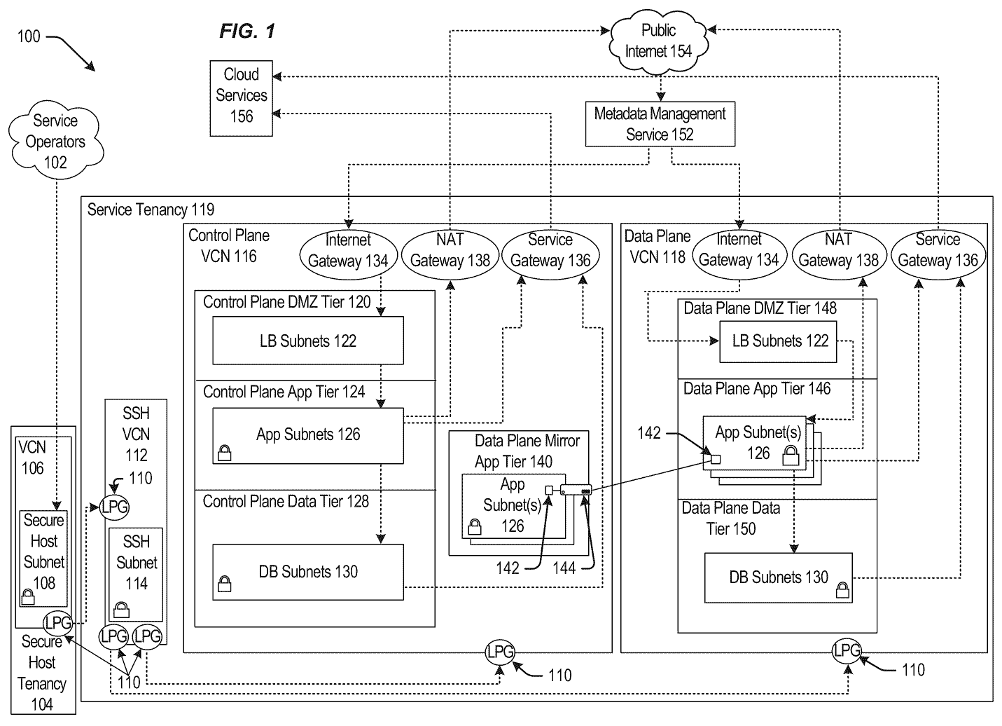

FIG. 1 is a block diagram 100 illustrating an example pattern of an IaaS architecture, according to at least one embodiment. Service operators 102 can be communicatively coupled to a secure host tenancy 104 that can include a virtual cloud network (VCN) 106 and a secure host subnet 108. In some examples, the service operators 102 may use one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124 and an Internet gateway 134 that can be contained in the control plane VCN 116, and the app subnet(s) 126 can be communicatively coupled to the DB subnet(s) 130 contained in the control plane data tier 128 and a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively coupled to cloud services 156.

In some examples, the service gateway 136 of the control plane VCN 116 or of the data plane VCN 118 can make application programming interface (API) calls to cloud services 156 without going through public Internet 154. The API calls to cloud services 156 from the service gateway 136 can be one-way: the service gateway 136 can make API calls to cloud services 156, and cloud services 156 can send requested data to the service gateway 136. But, cloud services 156 may not initiate API calls to the service gateway 136.

In some examples, the secure host tenancy 104 can be directly connected to the service tenancy 119, which may be otherwise isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118, and the data plane mirror app tier 140 of the control plane VCN 116 can communicate with the data plane app tier 146 of the data plane VCN 118 via VNICs 142 that can be contained in the data plane mirror app tier 140 and the data plane app tier 146.

In some examples, users of the system can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response to this determination, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configuration to, resources contained in the data plane VCN 118.

In some embodiments, the control plane VCN 116 and the data plane VCN 118 can be contained in the service tenancy 119. In this case, the user, or the customer, of the system may not own or operate either the control plane VCN 116 or the data plane VCN 118. Instead, the IaaS provider may own or operate the control plane VCN 116 and the data plane VCN 118, both of which may be contained in the service tenancy 119. This embodiment can enable isolation of networks that may prevent users or customers from interacting with other users', or other customers', resources. Also, this embodiment may allow users or customers of the system to store databases privately without needing to rely on public Internet 154, which may not have a desired level of threat prevention, for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119, which may be isolated from public Internet 154.

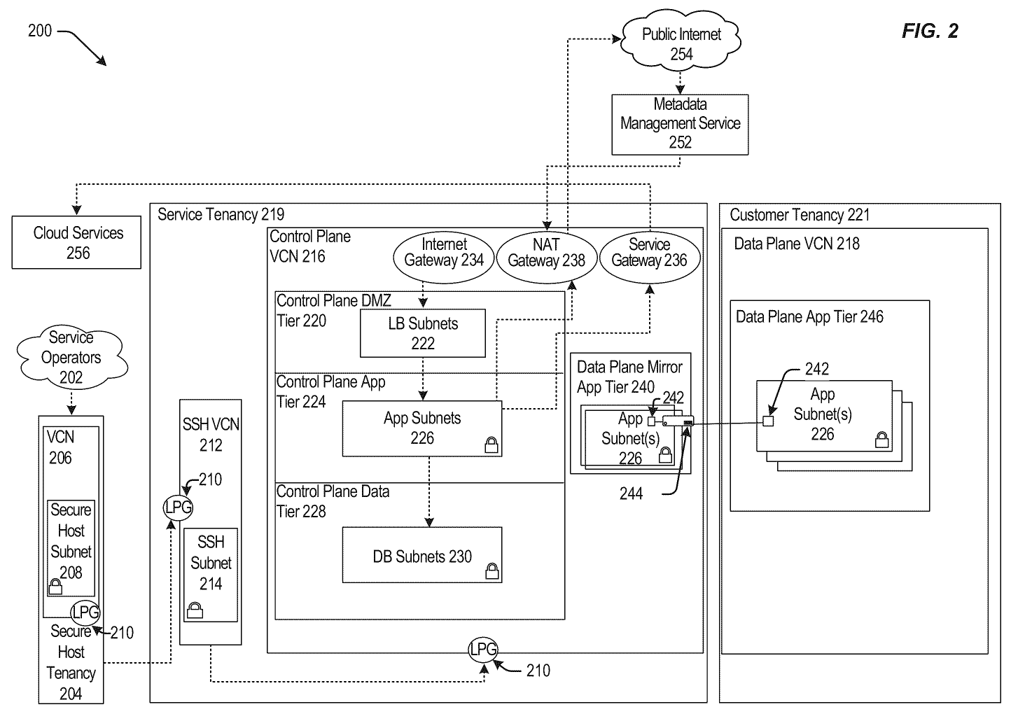

FIG. 2 is a block diagram 200 illustrating another example pattern of an IaaS architecture, according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1) that can be contained in the control plane VCN 216, and the app subnet(s) 226 can be communicatively coupled to the DB subnet(s) 230 contained in the control plane data tier 228 and a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively coupled to cloud services 256 (e.g., cloud services 156 of FIG. 1).

In some examples, the data plane VCN 218 can be contained in the customer tenancy 221. In this case, the IaaS provider may provide the control plane VCN 216 for each customer, and the IaaS provider may, for each customer, set up a unique compute instance 244 that is contained in the service tenancy 219. Each compute instance 244 may allow communication between the control plane VCN 216, contained in the service tenancy 219, and the data plane VCN 218 that is contained in the customer tenancy 221. The compute instance 244 may allow resources, that are provisioned in the control plane VCN 216 that is contained in the service tenancy 219, to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment, or other usage of resources, of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in “Region 1,” and cloud service “Deployment 1,” may be located in Region 1 and in “Region 2.” If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

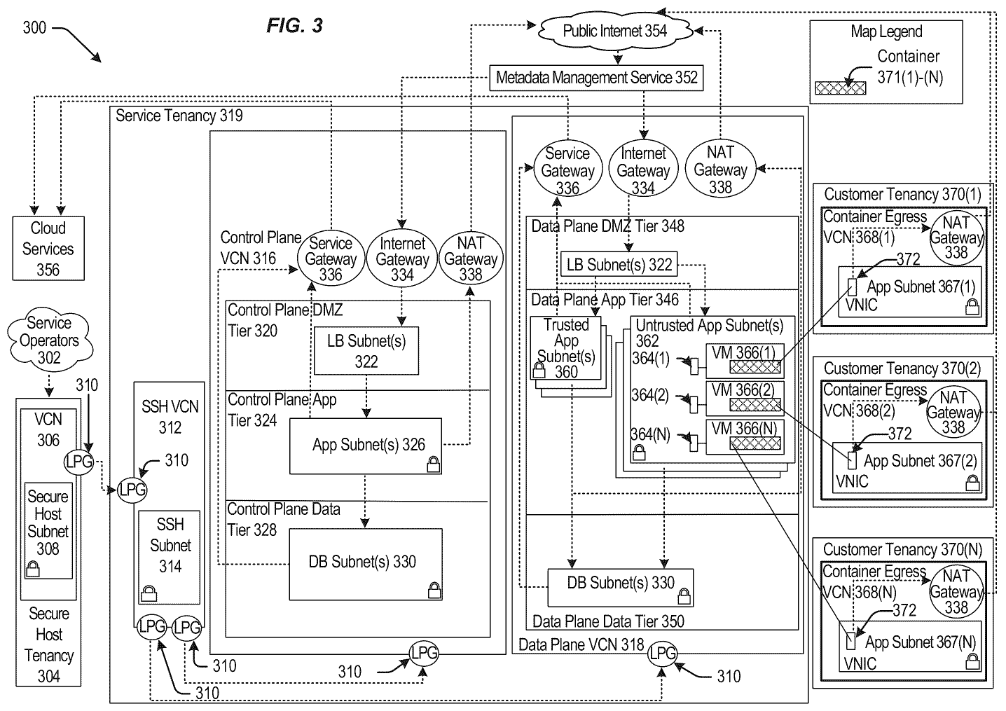

FIG. 3 is a block diagram 300 illustrating another example pattern of an IaaS architecture, according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316, and the app subnet(s) 326 can be communicatively coupled to the DB subnet(s) 330 contained in the control plane data tier 328 and to a service gateway 336 (e.g., the service gateway of FIG. 1) and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360 and untrusted app subnet(s) 362 of the data plane app tier 346 and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Each tenant VM 366(1)-(N) can be communicatively coupled to a respective app subnet 367(1)-(N) that can be contained in respective container egress VCNs 368(1)-(N) that can be contained in respective customer tenancies 370(1)-(N). Respective secondary VNICs 372(1)-(N) can facilitate communication between the untrusted app subnet(s) 362 contained in the data plane VCN 318 and the app subnet contained in the container egress VCNs 368(1)-(N). Each container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management system 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively coupled to cloud services 356.

In some embodiments, the data plane VCN 318 can be integrated with customer tenancies 370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. Each VM 366(1)-(N) may be connected to one customer tenancy 370. Respective containers 371(1)-(N) contained in the VMs 366(1)-(N) may be configured to run the code. In this case, there can be a dual isolation (e.g., the containers 371(1)-(N) running code, where the containers 371(1)-(N) may be contained in at least the VM 366(1)-(N) that are contained in the untrusted app subnet(s) 362), which may help prevent incorrect or otherwise undesirable code from damaging the network of the IaaS provider or from damaging a network of a different customer. The containers 371(1)-(N) may be communicatively coupled to the customer tenancy 370 and may be configured to transmit or receive data from the customer tenancy 370. The containers 371(1)-(N) may not be configured to transmit or receive data from any other entity in the data plane VCN 318. Upon completion of running the code, the IaaS provider may kill or otherwise dispose of the containers 371(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 371(1)-(N) that can be contained in the VM 366(1)-(N) of each customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

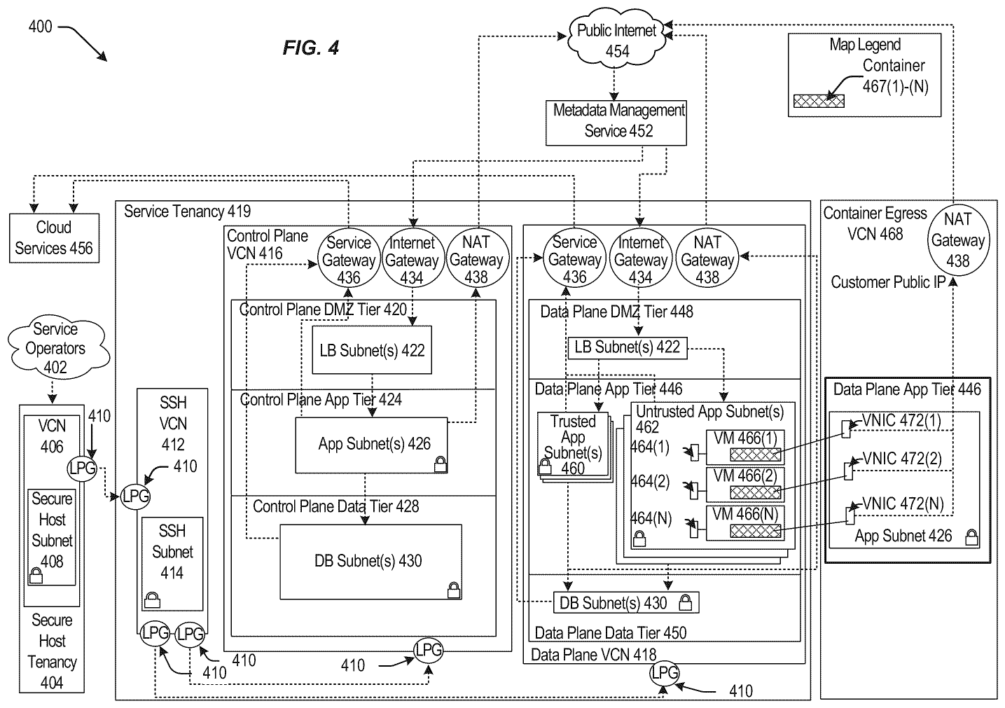

FIG. 4 is a block diagram 400 illustrating another example pattern of an IaaS architecture, according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1), and the SSH VCN 412 can be communicatively coupled to a control plane VCN 416 (e.g., the control plane VCN 116 of FIG. 1) via an LPG 410 contained in the control plane VCN 416 and to a data plane VCN 418 (e.g., the data plane 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424 and to an Internet gateway 434 (e.g., the Internet gateway 134 of FIG. 1) that can be contained in the control plane VCN 416, and the app subnet(s) 426 can be communicatively coupled to the DB subnet(s) 430 contained in the control plane data tier 428 and to a service gateway 436 (e.g., the service gateway of FIG. 1) and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Each tenant VM 466(1)-(N) can run code in a respective container 467(1)-(N), and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management system 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively coupled to cloud services 456.

In some examples, the pattern illustrated by the architecture of block diagram 400 of FIG. 4 may be considered an exception to the pattern illustrated by the architecture of block diagram 300 of FIG. 3 and may be desirable for a customer of the IaaS provider if the IaaS provider cannot directly communicate with the customer (e.g., a disconnected region). The respective containers 467(1)-(N) that are contained in the VMs 466(1)-(N) for each customer can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real-time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that requests a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, 400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

### Computer System

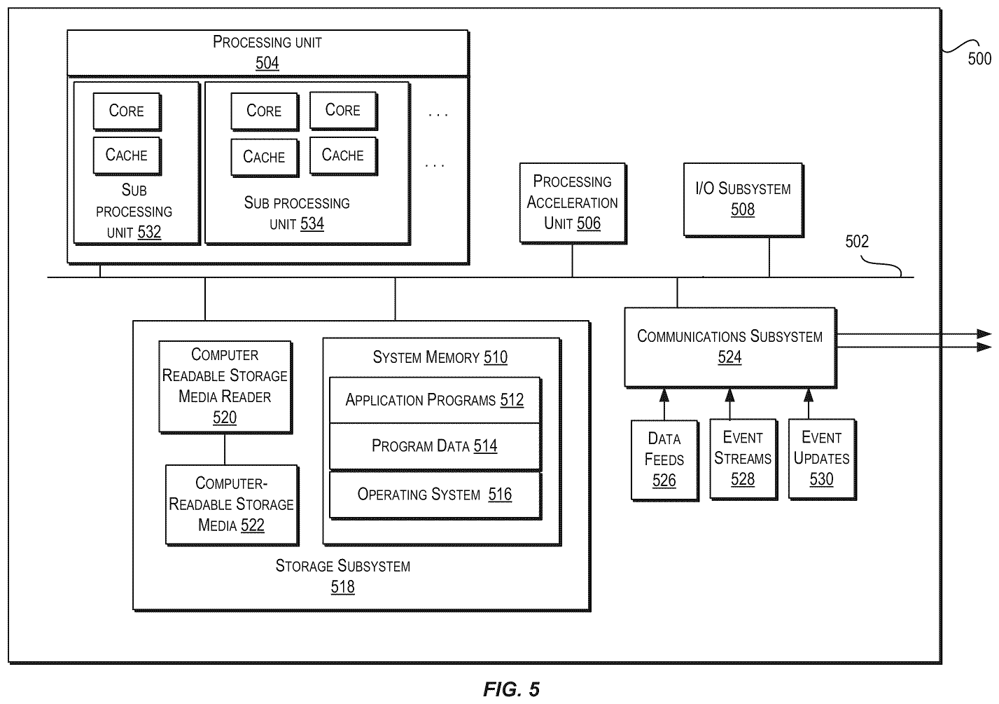

FIG. 5 illustrates an example computer system 500, in which various embodiments described herein may be implemented. The system 500 may be used to implement any of the computer systems described above. As shown in the figure, computer system 500 includes a processing unit 504 that communicates with a number of peripheral subsystems via a bus subsystem 502. These peripheral subsystems may include a processing acceleration unit 506, an I/O subsystem 508, a storage subsystem 518 and a communications subsystem 524. Storage subsystem 518 includes tangible computer-readable storage media 522 and a system memory 510.

Bus subsystem 502 provides a mechanism for letting the various components and subsystems of computer system 500 communicate with each other as intended. Although bus subsystem 502 is shown schematically as a single bus, alternative embodiments of the bus subsystem may utilize multiple buses. Bus subsystem 502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 504, which can be implemented as one or more integrated circuits (e.g., a conventional microprocessor or microcontroller), controls the operation of computer system 500. One or more processors may be included in processing unit 504. These processors may include single core or multicore processors. In certain embodiments, processing unit 504 may be implemented as one or more independent processing units 532 and/or 534 with single or multicore processors included in each processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, some or all of the program code to be executed can be resident in processor(s) 504 and/or in storage subsystem 518. Through suitable programming, processor(s) 504 can provide various functionalities described above. Computer system 500 may additionally include a processing acceleration unit 506, which can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 500 may comprise a storage subsystem 518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 504 provide the functionality described above. Storage subsystem 518 may also provide a repository for storing data used in accordance with the present disclosure.

As depicted in the example in FIG. 5, storage subsystem 518 can include various components including a system memory 510, computer-readable storage media 522, and a computer readable storage media reader 520. System memory 510 may store program instructions that are loadable and executable by processing unit 504. System memory 510 may also store data that is used during the execution of the instructions and/or data that is generated during the execution of the program instructions. Various different kinds of programs may be loaded into system memory 510 including but not limited to client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 510 may include a basic input/output system (BIOS) containing basic routines that help to transfer information between elements within computer system 500, such as during start-up.

Computer-readable storage media 522 may represent remote, local, fixed, and/or removable storage devices plus storage media for temporarily and/or more permanently containing, storing, computer-readable information for use by computer system 500 including instructions executable by processing unit 504 of computer system 500.

Computer-readable storage media 522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments communications subsystem 524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 524 may also be configured to receive data in the form of continuous data streams, which may include event streams 528 of real-time events and/or event updates 530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### Multi-Architecture Rapid Testing

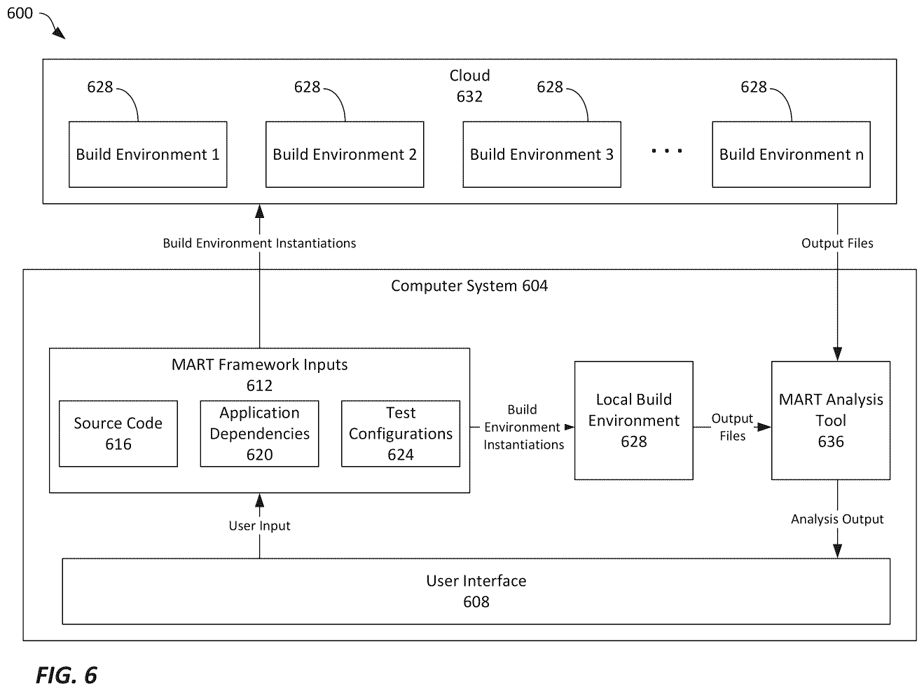

As described above, a developer may wish to test and analyze different scenarios for, among other things, porting source code originally intended for a given architecture or operating system. FIG. 6 is a block diagram illustrating a system architecture 600 for executing multi-architecture rapid testing, according to at least one embodiment. The system architecture 600 includes a computer system 604 that may be substantially similar to the computer system 500 described above with respect to FIG. 5. For example, the computer system 604 may include a processing unit substantially similar to the processing unit 504, a processing acceleration unit substantially similar to the processing acceleration unit 506, a I/O subsystem substantially similar to the I/O subsystem 508, a storage subsystem substantially similar to the storage subsystem 518, and/or a communications subsystem substantially similar to the communications subsystem 524.

The computer system 604 is provided with a multi-architecture rapid testing (“MART”) framework (e.g., a software application) for testing and analyzing different build scenarios for a given set of source code. It should be understood that functionality described herein as being performed via the computer system 604 may be distributed in various combinations. For example, as described below, in some embodiments, instances of build environments may be executed within a cloud infrastructure (e.g., one or more of the infrastructures described with respect to FIGS. 1-4) and, in some embodiments, the analysis of the test results or a portion thereof may similarly be performed in the cloud infrastructure.

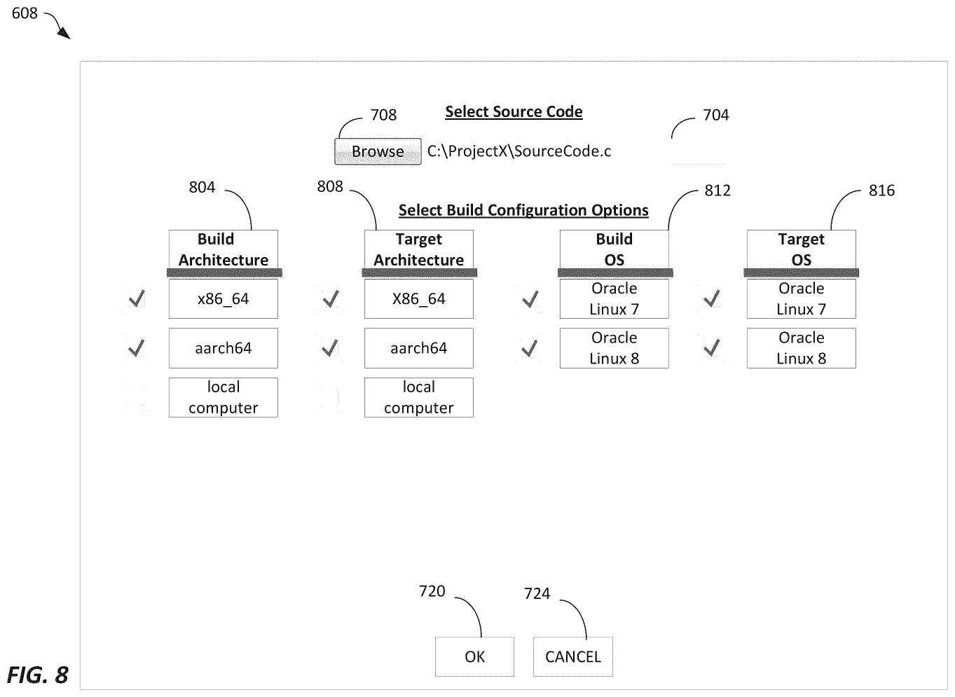

The computer system 604 (e.g., through execution of the MART application) is configured to generate and output a user interface 608 for receiving user inputs, such as MART framework inputs 612. The MART framework inputs 612 include, for example, a set of source code 616 to be tested and analyzed using the MART framework, application dependencies 620 associated with the source code 614, a set of test scenarios 624, or a combination thereof. As described with respect to FIG. 8, in some embodiments, the computer system 604 receives test scenario options through the user interface 608, which the computer system 604 uses to generate a set of test scenarios (e.g., based on permutations of one or more of the received options). Also, in some embodiments, the computer system 604 may be configured to receive one or more of the above inputs from another application or source. For example, the set of source code may be received from another application or computer system and, in some embodiments, the computer system 604 may have access to a stored set of test scenarios 624 and, thus, may not receive scenarios from a user or another input source.

Each test scenario 624 may specify a build architecture and a compilation method. Each test scenario 624 may also specify a target architecture, a build operating system (“OS”), a target OS, or a combination thereof. Table 1, below, provides a non-limiting example set of fourteen test scenarios 624 for a given set of CPU architectures, operating systems, and compilation methods:

TABLE 1

| | Build | Target | Build | Target | Compilation | | Run in |
|---|---|---|---|---|---|---|---|
| | Architecture | Architecture | OS | OS | Strategy | Emulated? | container? |
| 1 | x86_64 | aarch64 | Oracle | Oracle | Native | Yes | Yes |
| | | | Linux | Linux 7 | | | |
| | | | 7 | | | | |
| 2 | x86_64 | aarch64 | Oracle | Oracle | Native | Yes | Yes |
| | | | Linux | Linux 8 | | | |
| | | | 7 | | | | |
| 3 | x86_64 | aarch64 | Oracle | Oracle | Cross- | No | No |
| | | | Linux | Linux 7 | compiled | | |
| | | | 7 | | | | |
| 4 | x86_64 | aarch64 | Oracle | Oracle | Native | Yes | Yes |
| | | | Linux | Linux 7 | | | |
| | | | 8 | | | | |
| 5 | x86_64 | aarch64 | Oracle | Oracle | Native | Yes | Yes |
| | | | Linux | Linux 8 | | | |
| | | | 8 | | | | |
| 6 | x86_64 | aarch64 | Oracle | Oracle | Cross- | No | Yes |
| | | | Linux | Linux 8 | compiled | | |
| | | | 8 | | | | |
| 7 | aarch64 | aarch64 | Oracle | Oracle | Native | No | Yes |
| | | | Linux | Linux 7 | | | |
| | | | 7 | | | | |
| 8 | aarch64 | aarch64 | Oracle | Oracle | Native | No | Yes |
| | | | Linux | Linux 8 | | | |
| | | | 7 | | | | |
| 9 | aarch64 | aarch64 | Oracle | Oracle | Native | No | No |
| | | | Linux | Linux 7 | | | |
| | | | 7 | | | | |
| 10 | aarch64 | aarch64 | Oracle | Oracle | Native | No | Yes |
| | | | Linux | Linux 7 | | | |
| | | | 8 | | | | |
| 11 | aarch64 | aarch64 | Oracle | Oracle | Native | No | Yes |
| | | | Linux | Linux 8 | | | |
| | | | 8 | | | | |
| 12 | aarch64 | aarch64 | Oracle | Oracle | Native | No | No |
| | | | Linux | Linux 8 | | | |
| | | | 8 | | | | |
| 13 | Local | aarch64 | Local | Oracle | Native | Varies | Yes |
| | computer | | OS | Linux 7 | | | |
| 14 | Local | aarch64 | Local | Oracle | Native | Varies | Yes |
| | computer | | OS | Linux 8 | | | |

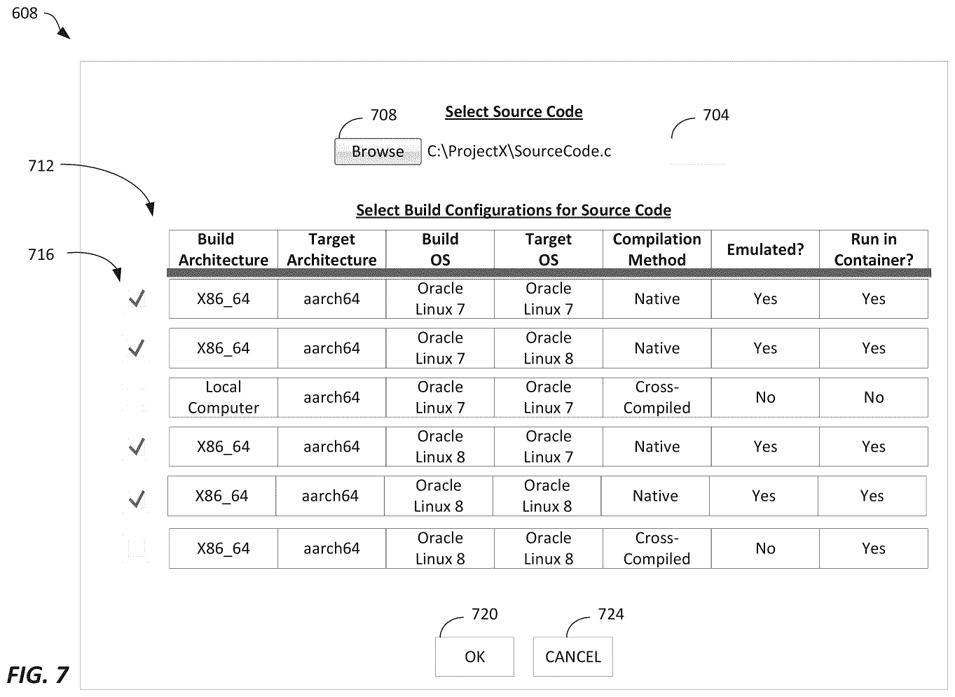

As noted above, the computer system 604 may receive (e.g., by way of the processing unit 504 executing the MART application) some or all of the MART framework inputs 612 through the user interface 608. FIG. 7 illustrates a first example of the user interface 608 for receiving MART framework inputs 612. As illustrated in FIG. 7, in some embodiments, the computer system 604 receives a file path 704 through the user interface 608 indicating a directory location of the set of source code 616, application dependencies (e.g., libraries, make files, or the like) associated with the set of source code 612, or a combination thereof. However, in some instances, the computer system 604 obtains one or more application dependencies without receiving the one or more application dependencies through user input (e.g., through the user interface 608). The user interface 608 may include a user-selectable browse button 708 and the computer system 604 may be configured to, in response to receiving a selection of the browse button 708, present a file manager window or tool within the user interface 608 for navigating to the file path 704 associated with the set of source code 612.

As illustrated in FIG. 7, the user interface 608 includes a list 712 of user-selectable test scenarios, which may represent a set of default or available test scenarios 624. In some instances, each test scenario in the list 712 is predefined and specifies a build architecture, a target architecture, a build operating system (“OS”), a target OS, a compilation method, an emulation indicator, a containerized indicator, or a combination thereof. For example, a first test scenario in the list 712 may specify an x86_64 build architecture, an aarch64 target architecture, an Oracle Linux 7 build OS, an Oracle Linux 7 target OS, and a native and emulated compilation that is run in a container. In contrast, a different test scenario in the list 712 may specify a local computer build architecture (e.g., the CPU architecture associated with the computer system 604), an aarch64 target architecture, an Oracle Linux 8 build OS, an Oracle Linux 8 target OS, and a cross-compilation method that is neither emulated nor run in a container. It should be understood that the test scenarios used by the computer system 604 may include more or fewer scenarios than those described above or illustrated with respect to FIG. 7. Additionally, the architectures, operating systems, and compilation methods included in the illustrated test scenarios 624 are not limited to those illustrated or described.

The user interface 608 also includes, for each respective test scenario in the list 712, a selection mechanism 716 (e.g., a radio button) for selecting the respective test scenario to be included in the set of test scenarios 624. However, in some instances, the user interface 608 provides a different type of selection mechanism 716 for receiving user selection of a particular test scenario, such as, for example, a drop-down menu listing the available test scenarios. Additionally, in some instances, the computer system 604 presents, via the user interface 608, a default selection of one or more test scenarios 712 (e.g., based on a past selection by the user, a default setting indicated by the user, etc.). Accordingly, as illustrated in FIG. 7, the computer system 604 may be configured to provide a list 712 of available test scenarios within a user interface and receive input from a user through the user interface selecting one or more of the available scenarios.

In response to receiving a selection of an “OK” button 720 included in the user interface 608, the computer system 604 may proceed with execution of multi-architecture rapid testing according to the selected test scenarios 712. Alternatively, in response to receiving a selection of a “Cancel” button 724 included in the user interface 608, the computer system 604 may be configured to cancel execution of the multi-architecture rapid testing. It should be understood that the user interface 608 may present additional selection or input mechanisms and may have various configurations of the input and selection mechanisms. The user interface 608 illustrated in FIG. 7 is for example purposes only.

FIG. 8 illustrates a second example of the user interface 608 for receiving MART framework inputs 612. Some aspects of the user interface 608 illustrated in FIG. 8 may be substantially similar to those illustrated in FIG. 7 and are therefore indicated with like numerals. In some instances, rather than providing the user with a list 712 of predefined test scenarios as illustrated in FIG. 7, the user interface 608 provides one or more lists of options for such test scenarios, wherein the computer system 604 uses selected options to generate applicable test scenarios 624. For example, as one non-limiting example, the user interface 608 in FIG. 8 includes a list 804 of one or more available build architectures, a list 808 of one or more available target architectures, a list 812 of one or more available build operating systems, and a list 816 of one or more available target operating systems. Although not illustrated in FIG. 8, in some embodiments, the user interface 608 may include additional lists of test scenario options, such as, for example, a list of available compilation methods. Also, in some embodiments, the user interface 608 may include fewer lists than those illustrated in FIG. 8. For example, in some embodiments, the user interface 608 may not include the lists 812 and 816 of operating systems.

Using the user interface 608, the computer system 604 provides available testing framework options and receives user selections of one or more of the available options. As described below, the computer system 604 uses the selected options to generate a set of test scenarios to be applied to the set of source code. As illustrated in FIG. 8, one or more selection mechanisms (e.g., radio buttons) may be included in the user interface 608 for selection of a particular option. However, similar to the user selection mechanism 716, the user interface 608 may provide other types of selection options for receiving user selections of test scenario options, such as, for example, a drop-down menu defining the respective options.

With respect to the user interface 608 illustrated in FIG. 8, the computer system 604 generates a plurality of test scenarios 624 based on permutations of (e.g., various combinations of) the received selected options. For example, in response to receiving a selection of two different build architectures (e.g., x86_64 and aarch64), two different target architectures (e.g., x86_64_64 and aarch64), two different build operating systems (e.g., Oracle Linux 7 and Oracle Linux 8), and two different target operating systems (e.g., Oracle Linux 7 and Oracle 8), the computer system 604 may generate a plurality of test scenarios covering the various combinations of these options. The computer system 604 may use a predefined compilation strategy for each respective test scenario 624 (e.g., cross-compilation for each test scenario 624 in which the build architecture differs from the target architecture). However, in some instances, the computer system 604 receives a selection of a compilation method (e.g., cross-compilation and/or native compilation) via the user interface 608. Also, in some embodiments, the computer system 604 is configured to determine whether to use a container for a particular test scenario 624, such as, for example, based on the build and target architecture of the test scenario 624. Similarly, the computer system 604 may be configured to determine whether emulation should be used for a particular test scenario 624 based the parameters of the test scenario 624 (e.g., based on the compilation method, the build and target architectures or OSs, or a combination thereof). For example, when the target architecture differs from the build architecture and native compilation is specified for a test scenario 624, the computer system 604 may specify in the respective test scenario that the respective build be containerized (e.g., set the container indicator to TRUE or YES).

The user interface 608 illustrated in FIG. 8 or similar user interfaces that allow a user to select one or more options for the test scenarios 624 improves the speed and efficiency at which a user can define test scenarios and analyze each test scenario. For example, by including selectable options within a user interface, a user can quickly establish a large set of test scenarios that satisfies the user's needs (e.g., without creating unneeded environments and binary files). In particular, by presenting build architecture and OS options and target architecture and OS options, the computer system 604 receives the user selections from the options and, in response, generates a set of appropriate test scenarios without requiring that the user specify each test scenario 624 and each parameter within the test scenario (which otherwise may be subject to user error and inappropriate or unneeded test scenarios 624). In particular, as described above, the computer system 604 may be configured to set the compilation method, emulation indicator, and container indicator for each test scenario based on the selected build and target options and included in a particular test scenario, which ensures each test scenario is properly defined and all appropriate permutations of the options are tested.

As noted above, it should be understood that, in some embodiments, the test scenarios 624 may be predefined and may not be based on user input. Similarly, in some embodiments, the test scenarios or options for such test scenarios may be received as a communication or instruction from a separate application or computer system. For example, in some embodiments, an application may communicate with the computer system 604 (e.g., through an application programming interface, a communication channel, a message exchange, etc.) and provide the set of source code, the test scenarios, test scenario options, or a combination thereof. In these situations, the computer system 604 is configured to process the received inputs as described herein with respect to inputs received from a user or retrieved from memory as part of stored default data.

Referring R again to FIG. 6, the computer system 604 is configured to instantiate a respective build environment 628, or compute instance 628, for each test scenario 624. For example, for fourteen respective test scenarios, the computer system 604 instantiates 14 respective build environments according to the respective test scenario. As used herein, the term “instantiate” may include creating an instance of a build environment (e.g., instantiating a container within the computer system 604), performing installations (e.g., installing dependencies) on an existing build environment (e.g., on a bare metal instance and/or virtual machine in the cloud 632) (e.g., as created by a user or another application), or a combination thereof. Each respective build environment 628 may be instantiated in the computer system 604 (locally) or in the cloud 632 (e.g., as a virtual machine, a bare metal machine, or the like) according to the respective test scenario 624 (e.g., according to a respective build architecture, a respective target architecture, a respective build operating system, and a respective target operating system specified by the respective test scenario 624). Accordingly, the computer system 604 may operate within any of the example IaaS architecture described above with respect to FIGS. 1-4 to deploy compute resources for one or more of the build environments 628. Such deployments may be managed via a Terraform stack. For containerized build environments 628 instantiated locally, the computer system 604 may also be configured to download or build containers from an external source (e.g., the Internet) or use a private or local container registry.

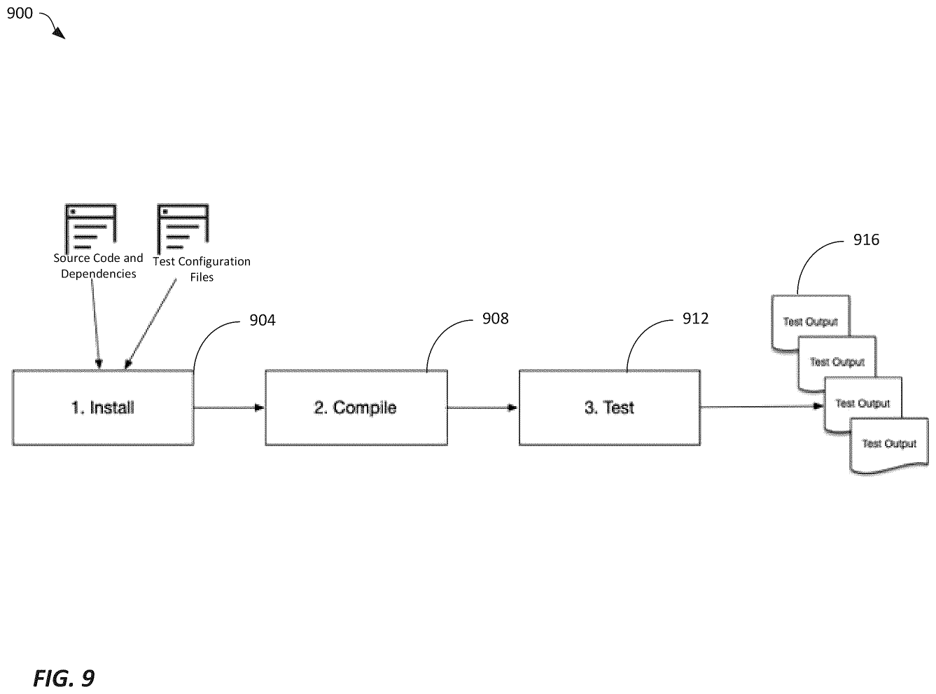

FIG. 9 illustrates a method 900 performed by the system architecture 600 (e.g., by way of the computer system 604) for instantiating build environments, compiling the set of source code 616 in a respective build environment 628, and analyzing the result compiled source code (binary file) for a respective build environment 628, such as, for example, by generating one or more metrics for the binary file that may be compared with similar metrics for other binary files. As illustrated in FIG. 9, the system architecture 600 (e.g., the computer system 604) performs an installation process to copy the application source code 616 and application dependencies 620 (e.g., libraries, Docker files used for testing different container images, etc.) to the respective build environment 628, and installs prerequisite tools, utilities, and toolchains on the respective build environment 628 for compiling the source code 616 (at block 904). The application dependencies 620 may also include resources (e.g., Oracle Cloud Infrastructure (“OCI”) compute resources) for deployment to the cloud 632 (e.g., using a Terraform stack).

The computer system 604 additionally copies one or more test configuration files associated with the respective test scenario 624, such as files containing build commands (e.g., for compiling the source code 616 according to a respective compilation method) and MART analysis scripts (described in greater detail below), to the respective build environment 628. The installation process also includes building container images in the respective build environment 628 when applicable (e.g., when the respective test scenario 624 specifies that the source code 616 be containerized).

The method 900 also includes compiling the set of source code 616 in the respective build environment 628 according to the respective test scenario 624 (e.g., native compilation or cross-compilation, container-based compilations, emulated compilation, or a combination thereof as defined in the provided test configuration files) to generate a respective binary file (at block 908). In some instances, container-based compilations (e.g., container-based compilations including native compilations, emulated compilations, and/or cross-compilations) are performed during the installation process when the container is built (at block 904).

Compilation of the set of source code 616 may result in generation of a single respective binary file or multiple respective binary files. For example, compilation of the set of source code 616 in the respective build environment 628 may optionally generate a first respective binary file including debug information and a smaller second respective binary file that is stripped of the debug information. Analysis of the generated application binaries may result in the creation of one or more output files, which are generated in a respective build environment 628. One or more analysis output files may contain language-specific information as well as general information about the executable and linkable format (“ELF”) binary file.

The method 900 further includes testing the respective binary file or files using the MART analysis scripts (at block 912). The system architecture 600 (e.g., the computer system 604, computer resources in the cloud 632, or a combination thereof) uses the MART analysis scripts to parse and analyze the respective binary files and the respective build environment in which the respective binary files are built and to generate a respective set of metrics associated with the respective binary files. Using the MART analysis scripts, the system architecture 600 (e.g., the computer system 604) may identify differences in binary files respectively compiled in different respective build environments. In some instances, the computer system 604 selects, using the MART analysis scripts, a base respective binary file (e.g., a natively or locally compiled respective binary file), and identifies similarities and dissimilarities between others of the respective binary files and the base respective binary file.

The MART analysis scripts may be, for example, ELF info scripts for parsing respective debug and stripped ELF binary files The respective MART analysis output files may be stored as, for example, YAML files, or another markup file format and may contain language-specific information or general information about the binary file. The MART analysis scripts may be run without modifying the original set of source code 616. The system architecture 600 (e.g., the computer system 604) may generate, for each respective build environment 628, a set of respective MART analysis output files containing the respective set of metrics, and the respective MART analysis output files are stored to, for example, the storage subsystem 518 (at block 916).

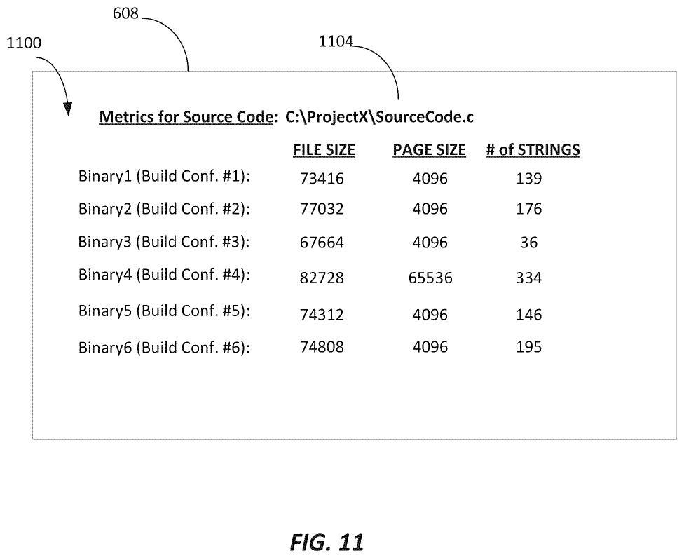

Each respective set of metrics may include a file size of the respective binary file, a page size of the respective build environment, a number of CPUs in the respective build environment, a model of CPUs in the respective build environment, CPU flags in the respective build environment, a number of strings included in the respective binary file, language-specific characteristics of the set of source code 616, packages included in the respective build environment, or a combination thereof. In some instances, the system architecture 600 (e.g., the computer system 604) generates an aggregated summary of the respective sets of metrics (e.g., using MART analysis tool 636 illustrated in FIG. 6), and provides the aggregated summary of the metrics within the user interface 608 (described in greater detail below with respect to FIG. 11). Alternatively, the aggregated summary, the MART analysis output files, or a combination thereof may be provided (e.g., transmitted) to another application or computer system. For example, as noted above, the inputs to the MART framework may be received from another application (e.g., through an API) and the results of the framework may be provided (e.g., the aggregate summary, the MART analysis output files, or a combination thereof) in response. Alternatively or in addition, the aggregate summary and/or the MART analysis output files may be processed (e.g., through the application of one or more rules) to select one of the test scenarios 624 (or a version thereof) as a suggested scenario for generating a binary file of the set of source code, such as, for example, for generating a deployment or production version of the binary file. For example, rules may be applied to the testing results to select one test scenario from the analyzed test scenarios having one or more metrics satisfying various thresholds or representing maximum metrics, and this selected test scenario may be presented to the user as a suggested compilation scenario to use for generating a binary file for deployment. The system architecture 600 may use the selected test scenario to generate the binary file for deployment in response to receiving user confirmation of the suggested compilation scenario. In other embodiments, the system architecture 600 may be configured to automatically generate the binary file using a suggested compilation scenario without presenting the suggested compilation scenario to a user, receiving a user confirmation, or both.

In some instances, both the respective debug binary and the respective stripped binary using the MART analysis scripts are analyzed to generate a respective MART analysis output file for each of the respective debug binary and the respective stripped binary.

As described above, the method 900 is performed for each respective build environment and this method may be performed in parallel or sequentially. Additionally, as described above, the number of respective build environments instantiated by the system 600 may be defined by the number of test scenarios, which may be defined based on permutations of available options. In some embodiments, these options may be defined or grouped as compute types and compilation methods. The term “compute type” may be used to refer to the respective build architecture, build OS, target architecture, and target OS specified by a respective test scenario 624, and the term “command” may be used to refer to a respective compilation method (e.g., cross-compilation or native compilation). However, the term “command” may also be used to refer to a respective compilation method and one or more parameters of the target environment (e.g., target architecture and target OS), whereas the term “compute type” may be used to refer to one or more parameters of the build environment (e.g., build architecture and build OS).

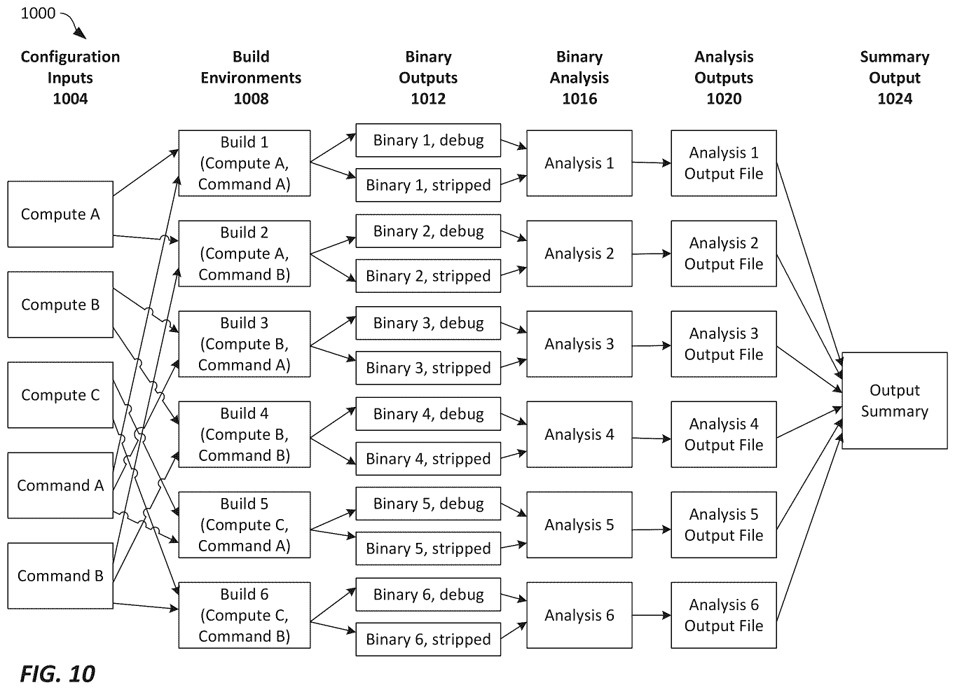

FIG. 10 illustrates an example block diagram 1000 of the MART process performed for a plurality of test scenarios including permutations of compute types and commands. In the example illustrated in FIG. 10, three compute types respectively referred to as Compute A. Compute B, and Compute C and two command types respectively referred to as Command A and Command B are specified as inputs 1004 (e.g., as options selected via the user interface 608). For each combination of compute type and command type (e.g., representing a test scenario), the system 600 generates a respective build environment 1008 (e.g., substantially similar to the build environments 628 described above with respect to FIG. 6). In the example illustrated in FIG. 10, the three different compute types and two different command types result in six different build environments 1008. For example, the system 600 generates build environment Build 1 according to Compute A and Command A, and generates a build environment Build 2 according to Compute A and Command B.

The set of source code 616 is compiled in each build environment 616 according to the respectively specified command, and two binary output files 1012 are generated for each build environment 1008 (e.g., a debug binary file and a stripped binary file). Using the MART analysis scripts, the system architecture 600 performs binary analysis 1016 of the binary output files 1012. The system 600 may perform separate analyses with respect to each build environment 1008. For example, as illustrated in FIG. 10, six analyses are respectively performed for the six build environments 1008 instantiated. In some instances, the system 600 performs separate analyses with respect to each binary file (e.g., debug or stripped) generated by a respective build environment 1008.

Each binary analysis 1016 generates at least one respective output file 1020 containing one or more metrics associated with the respective analysis. In some instances, metrics from each respective set of metrics contained in the respective MART analysis output files 1020 are aggregated and summarized in an output summary file 1024. For example, the output summary file 1024 may indicate which test scenarios resulted in binary files of a particular file size, CPU count, page size, and the like.

As noted above, the system 600 may present contents of the output summary file 1024 within the user interface 608. FIG. 11 illustrates an example set of metrics 1100 that may be included in the user interface 608. The user interface 608 may include the file name and/or file path 1104 of the set of source code 616 associated with the MART analysis. The metrics 1100 may identify each respective binary analyzed according to a file name of the binary and/or an indication of the respective test scenario 624 associated with the respective binary. As illustrated in FIG. 11, the metrics 1100 may further identify a file size of each respective binary, a page size of each respective build environment, and a number of strings included in each respective binary. However, other types of metrics that may be included in the user interface 608 are contemplated. For example, the user interface 608 may include an indication of a number of binary files having a particular file size, page size, string count, or the like. Alternatively or in addition, the user interface 608 may include a number of CPUs and/or models of CPUs used in respective build environments of the respective binaries. In addition to presenting aggregated metrics to the user interface 608, the system 600 may store the output summary file 1024 to, for example, the storage subsystem 518.

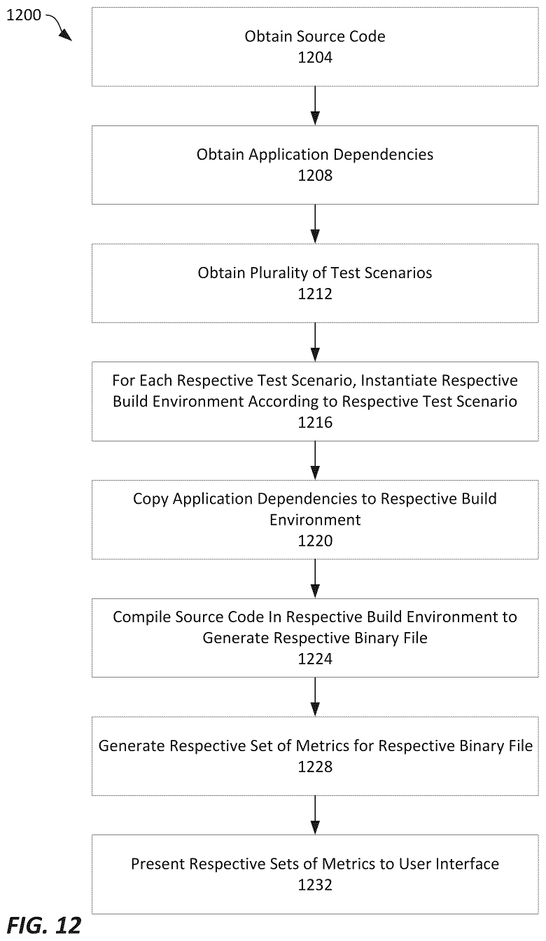

Referring now to FIG. 12, an example method 1200 for performing multi-architecture rapid testing is illustrated. The method 1200 is implemented, for example, by way of one or more electronic processors included in the system architecture 600 (e.g., one or more electronic processors included in the computer system 604 and/or one or more electronic processors included in the cloud 632). The method 1200 includes obtaining a set of source code (e.g., the set of source code 616) (at block 1204). The set of source code 616 may be predefined, may be obtained based on user input indicating a file location of the set of source code 616, or may be received from another application or device. The method 1200 also includes obtaining a set of application dependencies (e.g., the application dependencies 620) (at block 1208). Some or all of the application dependencies 620 may be predefined, may be obtained based on user input indicating a file location of some of all of the application dependencies 620, may be received from another application or device, or a combination thereof.

The method 1200 further includes obtaining, for example as user input via the user interface 608, a plurality of test scenarios (e.g., test scenarios 624) (at block 1212). As described above, each of the plurality of test scenarios 624 specifies a respective build architecture, a respective target architecture, a respective build operating system, a respective target operating system, a respective compilation method, or a combination thereof. A test scenario 624 may also specify an emulation indicator, a container indicator, or a combination thereof. As also described above, in some instances, obtaining the plurality of test scenarios 624 includes generating the plurality of test scenarios 624 based on permutations of a plurality of compute types and a plurality of compilation methods, which may be predefined and/or received via a user interface as selected options. For example, as described above, test scenario options received through a user interface may be used (alone or in combination with stored options, such as available compilation methods) to generate the plurality of test scenarios 624.

For each respective test scenario 624, the system architecture 600 instantiates a respective build environment (e.g., respective build environment 628) according to the respective test scenario 624 (e.g., a respective compute type) (at block 1216). In some instances, instantiating the respective build environment 628 includes instantiating a virtual machine. However, in some instances, one or more respective build environments 628 are instantiated locally in the computer system 600 and instantiating a build environment include instantiating a container within the local build environment 628. As also noted above, instantiating a build environment may include copying (installing) application dependencies and test configuration files to each respective build environment 628 (at block 1220). For example, in some embodiments, the system architecture 600 may use existing build environments created by a user or another application and, thus, in this scenario, instantiating a build environment 628 may include installing appropriate application dependencies, files, and data in an existing environment according to the respective test scenario. As noted above, build environments 628 may be instantiated as cloud infrastructures instances within a cloud infrastructure platform or architecture, such as, for example, one of the architectures described above with respect to FIGS. 1-4.

The method 1200 also includes, for each respective test scenario 624, compiling the set of source code 616 using the respective compilation method in the respective build environment 628 to generate a respective binary file for execution in the respective target architecture and the respective target operating system (at block 1224). In some instances, the respective binary file includes a plurality of respective binary files. For example, as described above, in some embodiments, compiling the source code 616 in a particular build environment 628 generates a respective debug binary and a respective stripped binary file.

The method 1200 also includes, for each respective test scenario 624, generating a respective set of one or more metrics for each respective binary file (at block 1228). The set of one or more metrics are generated using, for example, MART analysis scripts described above, and may include a file size of the respective binary file, a page size of the respective build environment, a number of CPUs in the respective build environment, a model of CPUs in the respective build environment, CPU flags in the respective build environment, a number of strings included in the respective binary file, or the like.

The method 1200 further includes outputting (e.g., within the user interface 608), the respective set of one or more metrics corresponding to each respective binary file (at block 1232). As described above, the computer system 604 may include the set of one or more metrics within the user interface 608 in the form of MART analysis output files generated for each respective binary and/or in the form of an aggregated summary of set of one or more metrics. As noted above, outputting metrics and/or an aggregate summary of the same within a user interface is only one possible use of the generated metrics and the metrics can be transmitted to other applications or devices, used to automatically generate a binary file for deployment (e.g., based on a test scenario having metrics satisfying various (e.g., user-configurable) thresholds, or a combination thereof. The metrics and/or the aggregate summary may also be used to identify existing (e.g., deployed) binary files that may be improved through recompiling or may require other maintenance or review.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A system comprising:
an electronic processor configured to:
obtain a set of source code;
obtain a plurality of test scenarios, wherein each of the plurality of test scenarios specifies a respective build architecture;
for each respective test scenario of the plurality of test scenarios:
instantiate a respective build environment according to the respective build architecture;
compile the set of source code in the respective build environment to generate a respective binary file, and
generate a respective set of one or more metrics for the respective binary file.

2. The system of claim 1, wherein each of the plurality of test scenarios further specifies a respective target architecture, and
wherein compiling the set of source code in the respective build environment comprises compiling the source code for execution in the respective target architecture.

3. The system of claim 1, wherein each of the plurality of test scenarios further specifies a respective build operating system and a respective target operating system, and
wherein instantiating the respective build environment comprises instantiating the respective build environment using the respective build operating system, and
wherein compiling the set of source code in the respective build environment comprises generating the respective binary file for execution in the respective target operating system.

4. The system of claim 1, wherein
each of the plurality of test scenarios further specifies a respective compilation method, and
wherein compiling the set of source code in the respective build environment comprises compiling the source code using the respective compilation method.

5. The system of claim 4, wherein the respective compilation method includes one selected from a group consisting of a native compilation, an emulated compilation, and a cross-compilation.

6. The system of claim 1, wherein the electronic processor is further configured to:
obtain a plurality of compute types; and
obtain a plurality of compilation methods,
wherein obtaining the plurality of test scenarios comprises generating the plurality of test scenarios based on permutations of the plurality of compute types and the plurality of compilation methods.

7. The system of claim 1, wherein each of the plurality of compute types includes a respective build architecture and a respective target architecture and wherein the plurality of compilation methods includes a native compilation, a emulated compilation, and a cross-compilation.

8. The system of claim 1, wherein instantiating the respective build environment includes copying application dependencies of the set of source code to a virtual machine.

9. The system of claim 1, wherein instantiating the respective build environment includes instantiating a container.

10. The system of claim 1, wherein the set of one or more metrics includes at least one selected from the group consisting of a file size of the respective binary file, a page size of the respective build environment, a number of CPUs in the respective build environment, a model of CPUs in the respective build environment, CPU flags in the respective build environment, and a number of strings included in the respective binary file.

11. A system comprising:
an electronic processor configured to:
receive, via a user interface, user input indicating a plurality of build architectures to be used in compiling a set of source code;
instantiate a plurality of build environments, wherein each of the plurality of build environments is instantiated respectively according to the plurality of build architectures;
compile the set of source code in each of the plurality of build environments to generate a respective binary file; and
present, via the user interface, a respective set of one or more metrics corresponding to each respective binary file.

12. The system of claim 11, wherein the user input received via the user interface further indicates a plurality of target architectures for execution of the binary files.

13. The system of claim 11, wherein the user input received via the user interface further indicates a plurality of build operating systems, wherein each of the plurality of build environments is instantiated respectively according to the plurality of build operating systems.

14. The system of claim 11, wherein the user input received via the user interface further indicates a plurality of target operating systems, wherein each respective binary file is generated respectively according to the plurality of target operating systems.

15. The system of claim 11, wherein the user input received via the user interface further indicates a plurality of compilation methods, wherein compiling the set of source code in each of the plurality of build environments comprises compiling the set of source code respectively according to the plurality of compilation strategies.

16. The system of claim 11, wherein the electronic processor is further configured to provide, via the user interface, a list of available build architectures and wherein the user input includes a selection of one or more build architectures from the list of available build architectures.

17. The system of claim 11, wherein the electronic processor is configured to receive the user input indicating the plurality of build architectures via a dropdown menu included in the user interface.

18. A method for testing binary files, the method comprising:
obtaining, with an electronic processor, a plurality of compute types and a plurality of compilation methods, each of the plurality of compute types specifying respective build architecture;
generating, with the electronic processor, a plurality of test scenarios based on permutations of the plurality of compute types and the plurality of compilation methods, wherein each of the plurality of test scenarios specifies a respective build architecture from the set of build architectures and a respective compilation method from the plurality of compilation methods; and
for each respective test scenarios of the plurality of test scenarios:
instantiating a respective build environment according to the respective build architecture,
compiling the set of source code in the respective build environment using the respective compilation method to generate a respective binary file, and
generating a respective set of one or more metrics for the respective binary file.

19. The method of claim 18, wherein each of the plurality of compute types further specifies a respective target architecture and wherein compiling the set of source code in the respective build environment includes generating the respective binary file for the respective target architecture.

20. The method of claim 18, wherein the set of one or more metrics includes at least one selected from the group consisting of a file size of the respective binary file, a page size of the respective build environment, a number of CPUs in the respective build environment, a model of CPUs in the respective build environment, CPU flags in the respective build environment, and a number of strings included in the respective binary file.
